(19) United States
(12) Patent Application Publication
(10) Pub. No.: US 2019/0206031 A1
(43) Pub. Date: Jul. 4, 2019

(54) Facial Contour Correcting Method and Device

(71) Applicant: Seerslab, Inc., Seoul (KR)

(72) Inventors: Jae Cheol Kim, Seoul (KR); Jin Wook Chong, Santa Clara, CA (US)

(73) Assignee: Seerslab, Inc., Seoul (KR)

(21) Appl. No.: 16/304,337

(22) PCT Filed: May 26, 2017
(86) PCT No.: PCT/KR2017/005528

§ 371 Date: Nov. 26, 2018

(30) Foreign Application Priority Data
May 26, 2016 (KR) 10-2016-0064608

(51) Int. Cl. G06T 5/00; G06T 5/20

(52) U.S. Cl. CPC G06T 5/006; G06T 5/20; G06T 2207/20096; G06T 2207/20192; G06T 2207/30201

(57) ABSTRACT

A method and device for correcting facial contours is disclosed. The method for correcting facial contours according to one embodiment of the present invention comprises: a step of displaying a subject captured by a camera; a step of selecting, based on user input, one of a plurality of facial contours for correcting facial contours of an object included in the subject; a step of using any one selected facial contour to correct the facial contours of the object in real time, and; a step of, upon receiving a capture command through user input, generating an image of the subject, including the object having the corrected facial contours.

### TECHNICAL FIELD

The present invention relates to facial contour correcting. More specifically, the present invention relates to a facial contour correcting method and device able to correct facial contours of an object included in a subject.

### BACKGROUND ART

Today, most mobile devices contain an integrated digital camera. Users use the integrated camera module to capture photos and video. Captured image data is processed in accordance with pre-defined technical standards, then saved in the memory of the mobile device. Image data saved on the mobile device can be played or displayed on the device, or be transmitted to another device through wireless communication.

In order for such images to be played or transmitted, image data must be obtained by the mobile device through the integrated digital camera. To this end, a user manipulates the digital camera. When the user begins capturing photo or video, light detected by an image sensor in the camera module of the mobile device is converted into electric signals. Through known processes in the hardware and software of the camera module, image processing such as compression and error and distortion correction is carried out, then the image is saved in memory as a file.

### DETAILED DESCRIPTION OF THE INVENTION

### Technical Problem

The embodiments of the present invention provide a facial contour correcting method and device able to correct facial contours of an object included in a subject.

Specifically, the embodiments of the present invention provide a facial contour correcting method and device able to use user-selected or auto-selected facial contours to pre-process and correct facial contours of an object displayed on a viewfinder.

### Technical Solution

The method for correcting facial contours according to one embodiment of the present invention comprises: a step of displaying a subject captured by a camera; a step of selecting, based on user input, one of a plurality of facial contours for correcting facial contours of an object included in the subject; a step of using any one selected facial contour to correct the facial contours of the object in real time, and; a step of, upon receiving a capture command through user input, generating an image of the subject, including the object having the corrected facial contours, wherein the step of selecting based on user input is characterized in that it provides, based on each of the setting items of preset user information, recommended facial contours corresponding to the user information among the plurality of facial contours; in that any one recommended facial contour of the recommended facial contours provided is selected based on the user input, and; in that the user information includes at least one of age, sex, race and skin color, and the step of selecting based on user input is characterized in that data on facial contour preferences according to each of age, sex, race and skin color, which are setting items of the user information, is collected, and; in that the collected data is used to provide the recommended facial contours.

In the step of selecting based on user input, the facial contours of the object may be detected, and the recommended facial contours may be provided to additionally reflect the detected facial contours.

In the step of correcting the facial contours of the object, the facial contours of the object may be corrected by recognizing the face of the object and extracting face feature points, then using face feature point information for the selected facial contour to carry out displacement mapping for the extracted face feature points in real time.

The step of correcting the facial contours of the object may include: a step of fine-adjusting the selected facial contour based on user input, and; a step of using the fine-adjusted facial contour to correct the facial contours of the object in real time.

The method for correcting facial contours according to another embodiment of the present invention comprises: a step of displaying a subject captured by a camera; a step of automatically selecting any one of a plurality of facial contours which have been preset based on big data statistics for each of the setting items in user information which has been set by a user and saved beforehand; a step of using the automatically selected facial contour to automatically correct the facial contours of an object included in the subject in real time, and; a step of, when a capture command is received through user input, an image of the subject including the object with the corrected facial contours is generated, and is characterized in that the user information includes at least one of age, sex, race and skin color; in that the step of selecting based on user input is characterized in that data on facial contour preferences according to each of age, sex, race and skin color, which are setting items of the user information, is collected, and; in that the collected data is used to provide the recommended facial contours.

In the step of automatically selecting a facial contour, the facial contours of the object may be detected, and the detected facial contours may be additionally reflected in automatically selecting a facial contour.

In the step of automatically correcting the facial contours of the object, the facial contours of the object may be automatically corrected by recognizing the face of the object and extracting face feature points, then using face feature point information for the selected facial contour to carry out displacement mapping for the extracted face feature points in real time.

The device for correcting facial contours according to the present invention comprises: a display which displays a subject captured by a camera; a selection part wherein one of a plurality of facial contours for correcting facial contours of an object included in the subject is selected based on user input; a correction part wherein the selected facial contour is used to correct the facial contours of the object in real time, and; a capture part wherein an image of the subject including the object with the corrected facial contours is generated upon receiving a capture command through user input, further comprises a recommendation part where, based on information on each of the setting items in preset user information, recommended facial contours corresponding to the user information are provided from the plurality of facial contours, and is characterized in that the user information includes at least one of age, sex, race and skin color; in that the recommendation part collects data on facial contour preferences according to each of age, sex, race and skin color, which are setting items of the user information, and; in that the collected data is used to provide the recommended facial contours.

The recommendation part may detect the facial contours of the object, and reflect the detected facial contours additionally in providing the recommended facial contours.

The correction part may recognize the face of the object and extracting face feature points, then use face feature point information for the selected facial contour to carry out displacement mapping for the extracted face feature points in real time, thereby correcting the facial contours of the object.

The correction part may, if the selected facial contour is find-adjusted based on user input, use the find-adjusted facial contour to correct the facial contours of the object in real time.

The device for correcting facial contours according to the present invention comprises: a display which displays a subject captured by a camera; a selection part wherein any one of a plurality of facial contours which have been preset based on big data statistics for each of the setting items in user information which has been set by a user and saved beforehand is automatically selected; a correction part wherein the selected facial contour is used to correct the facial contours of the object in real time, and; a capture part wherein an image of the subject including the object with the corrected facial contours is generated upon receiving a capture command through user input, and is characterized in that the user information includes at least one of age, sex, race and skin color; in that data on facial contour preferences according to each of age, sex, race and skin color, which are setting items of the user information, are collected in the step of automatically selecting a facial contour, and; in that the collected data is used to provide the recommended facial contours.

The selection part may detect the facial contours of the object, then reflect the detected facial contours additionally in automatically selecting the facial contour.

The correction part may recognize the face of the object and extracting face feature points, then use face feature point information for the selected facial contour to carry out displacement mapping for the extracted face feature points in real time, thereby correcting the facial contours of the object.

The method for correcting facial contours according to another embodiment of the present invention comprises: a step of displaying a subject captured by a camera; a step of selecting a facial contour for correcting the facial contours of an object included in the subject; a step of using the selected facial contour to correct the facial contours of the object in real time; a step of viewing facial contours corresponding to at least one sticker or effect to be applied to the subject and which has been selected from among a plurality of stickers or effects provided beforehand; a step of using the viewed facial contours to correct the facial contours of the object included in the subject, and; a step of generating an image of the subject with the object with the corrected facial contours upon receiving a capture command through user input.

In the step of viewing facial contours, user information which has been set and saved beforehand by a user may be reflected in viewing the facial contours corresponding to the selected sticker or effect.

In the step of viewing facial contours, if a selected sticker or effect includes a human character, facial contours corresponding to the facial contours of the human character can be viewed.

### BENEFITS OF THE INVENTION

According the embodiments of the present invention, by using user-selected or automatically selected facial contours to pre-process and correct the facial contours of an object displayed in a viewfinder, the face of the subject being captured can be corrected to look more attractive.

According to the embodiments of the present invention, it is possible to capture images applying various facial contours to the subject, making it possible to capture images of a subject having a variety of facial contours.

According to the embodiments of the present invention, by using big data statistics to provide recommended facial contours corresponding to user information set by a user, or by applying optimal facial contours automatically, it is possible to correct the face of a subject by applying facial contours which are frequently selected according to user information, thereby carrying out facial contour correction suitable for a user.

### BRIEF DESCRIPTION OF DRAWINGS

FIG. 1 is an exemplary diagram for explaining the present invention.

FIG. 2 is a flow chart illustrating the method for correcting facial contours according to one embodiment of the present invention.

FIG. 3 is a flow chart illustrating one embodiment of step S220 illustrated in FIG. 2.

FIG. 4 is a flow chart illustrating one embodiment of step S240 illustrated in FIG. 2.

FIGS. 5 and 6 are exemplary diagrams for explaining the operation of the method according to embodiments of the present invention.

FIG. 7 is a flow chart illustrating the operation of the method for correcting facial contours according to one embodiment of the present invention.

FIG. 8 illustrates the composition of the device for correcting facial contours according to one embodiment of the present invention.

FIG. 9 illustrates the composition of the device for correcting facial contours according to another embodiment of the present invention.

### BEST MODE(S) FOR CARRYING OUT THE INVENTION

In the following, embodiments of the present invention will be explained in detail with reference to the attached drawings. However, the present invention is not limited or restricted by these embodiments. Further, like reference symbols used in the respective drawings represent like members.

The gist of the present invention is to correct the facial contours with other facial contours by correcting, with the facial contours of a subject to be captured by a camera displayed on a viewfinder, the facial contours of an object included in the subject using any one facial contour among a plurality of predetermined facial contours.

Here, the object may include the user capturing the image, another person who is being photographed, or statues having a face shape, and the plurality of facial contours may include oval, long, round, square, heart and diamond-shaped contours. It goes without saying that the facial contours which may be used in the present invention may include various facial contours in addition to those facial contours stated above.

The embodiments of the present invention can, by pre-processing and correcting the facial contours of an object displayed on a viewfinder with a facial contour selected by a user, capture and save images of objects having corrected facial contours.

In the embodiments of the present invention, the facial contours of an object may be corrected using facial contours determined through selection by a user, but the present invention is not limited thereto, and the facial contours may be automatically corrected using facial contours selected automatically based on big data statistics and user information, then displayed on a viewfinder.

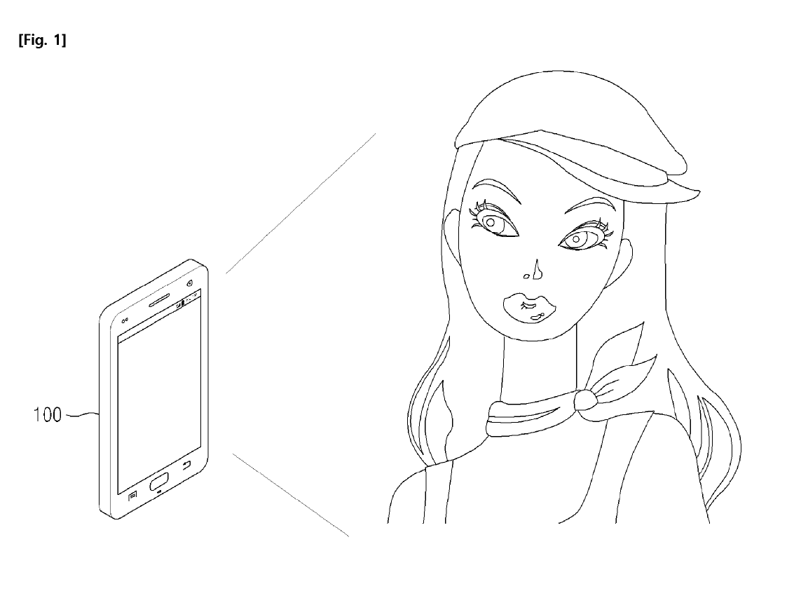

FIG. 1 is an exemplary diagram for explaining the present invention.

As illustrated in FIG. 1, the present invention may be adapted to a device (100) equipped with a camera, for example, a device such as a smart phone. By installing the present invention in a smart phone, etc., in the form of an application, it is possible to pre-process and correct the facial contours of an object such as a person included in a subject using any one facial contour among a plurality of predetermined facial contours, then capture photographs or video of the subject whose facial contours have been pre-processed and corrected.

Further, the present invention may provide at least one recommended facial contour among a plurality of facial contours, the at least one facial contour recommended based on at least one of user information which has been preset by a user or big data statistics regarding settings items which can be set by a user, then correct the facial contours of an object using the facial contour selected by a user among the recommended facial contours provided.

Here, the user information may comprise all items which can be set for a person, such as age, sex, race and skin color, etc.

Further, the present invention may, by automatically selecting a facial contour for correcting facial contours in accordance with user information using user information which has been preset by a user and big data statistics regarding settings items which can be set by a user, then using the automatically selected facial contour to automatically pre-process and correct the facial contours of the object, display a subject which has been automatically corrected using the automatically selected facial contour on a viewfinder.

In the following, for convenience's sake, it shall be assumed that the present invention is being carried out in a smart phone which is equipped with a camera. It shall be self-evident to a PHOSITA that the present invention is not limited to being carried out in a smart phone, and that the present invention may be adapted to all devices in which it may be installed.

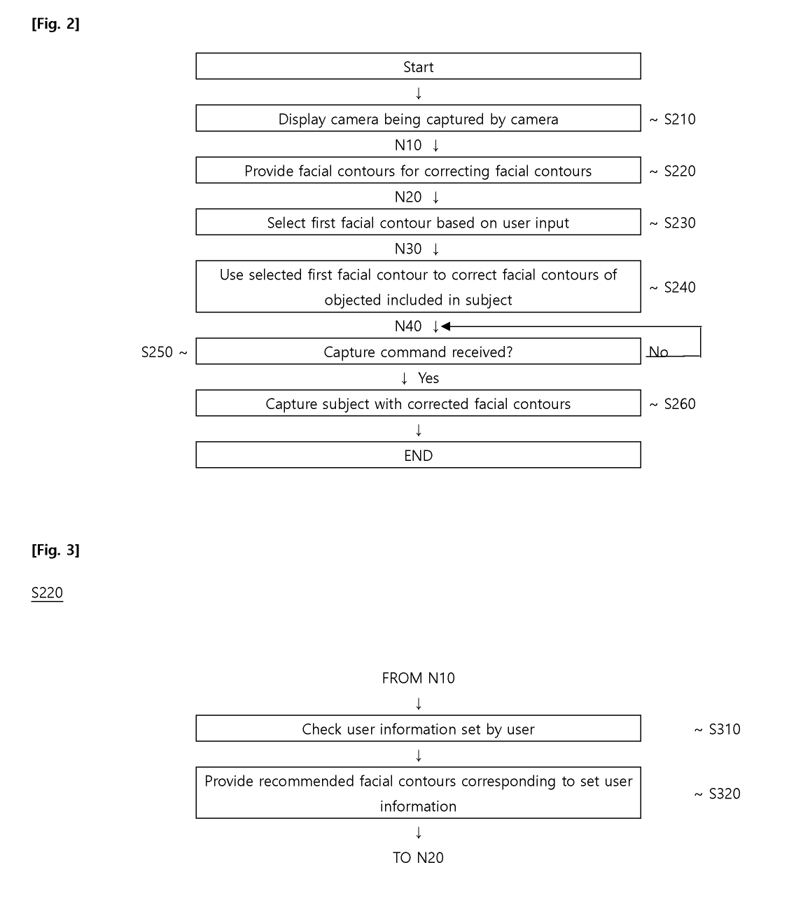

FIG. 2 is a flow chart illustrating the method for correcting facial contours according to one embodiment of the present invention, showing the operation of a method for correcting facial contours based on selection by a user.

Referring to FIG. 2, in the method for correcting facial contours according to one embodiment of the present invention, an application for the present invention is executed, then a subject captured by a camera on the device on which the application is installed, for example a subject including an object such as a person, is displayed on a screen (S210).

Various filter functions may be applied to the subject displayed in Step S210 depending on selection by a user, or various camera functions for capturing the subject may be applied.

In Step S210, the subject is displayed on the screen, and a plurality of facial contours for correcting the facial contours of the object included in the subject, which have been predetermined based on user input, are provided. Then, among the plurality of facial contours provided based on user input, one facial contour with which facial contour correction will be carried out, for example, a first facial contour, is selected (S220, S230).

Here, the facial contours provided in the present invention may include all facial contours which may be applied to a human face, for example, oval, long, round, square, heart, and diamond-shaped facial contours.

Here, in step S220, recommended facial contours among a plurality of predetermined facial contours may be provided to the user. This shall be explained with reference to FIG. 3.

As illustrated in FIG. 3, in Step S220, user information which has been set beforehand by a user is read, and recommended facial contours corresponding to the user information which has been set beforehand by the user are provided from among a plurality of facial contours to a user (S310, S320).

Here, the user information may include age (or age group), sex, race and skin color.

Here, in Step S320, by detecting the facial contours of a person being captured by a camera, then additionally taking into consideration the facial contours of the detected person, recommended facial contours may be provided from among a plurality of facial contours to reflect user information and the facial contours of the object. That is, the method according to the present invention can, based on at least one of age, sex, race and skin color information set by a user, and the facial contours of the object, recommend facial contours which can produce a more attractive image.

Further, in Step S320, recommended facial contours may be provided using big data statistics on age, sex, race and skin color. That is, in Step S320, recommended facial contours corresponding to the user information which has been set by a user can be provided based on big data statistics for setting items which can be set by a user, for example age, sex, race and skin color.

As the facial contours preferred by a user may differ based on age group, sex, race of skin color, by using a server of a business providing the present invention to collect such data globally, then carry out big data statistics on the collected data, it is possible to determined the facial contours preferred depending on age group, sex, race or skin color, and accordingly user big data statistics to provide recommended facial contours which correspond to user information which has been set by a user. Such big data statistics can be updated at certain time intervals, and information regarding facial contours recommended based on big data can be provided to the user's device through the server of the business, then downloaded onto the user's device and used when the present invention is carried out in the application.

When the first facial contour is selected by a user in Step S230, the facial contours of the object displayed on the viewfinder are pre-processed and corrected in real time using the selected first facial contour, and the object with corrected facial contours is displayed on the viewfinder (S240).

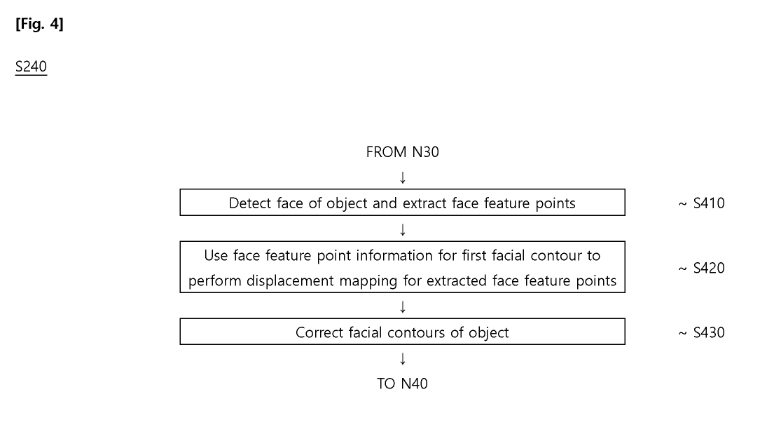

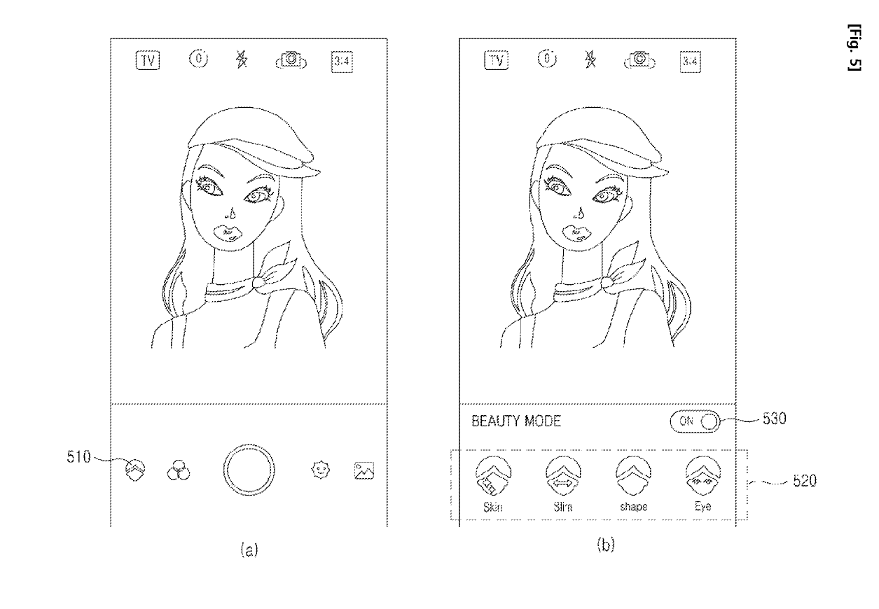

Here, in Step S240, as illustrated in FIG. 4, the camera preview automatically recognizes the face of an object, extracts face feature points, and tracks these face feature points in real time (S410).

When face feature points of the object are extracted through Step S410, a face feature point DB for each of the plurality of facial contours is used to perform real time displacement mapping of the facial feature points extracted from the face of the object, using face feature point information for the first facial contour selected in S230 (S420).

Here, the face feature points which have been displacement mapped in real time may be mapped as vertex data for OpenGL drawing to render an image captured by a user into a texture, thereby correcting and modifying the facial contours of the object into the first facial contour.

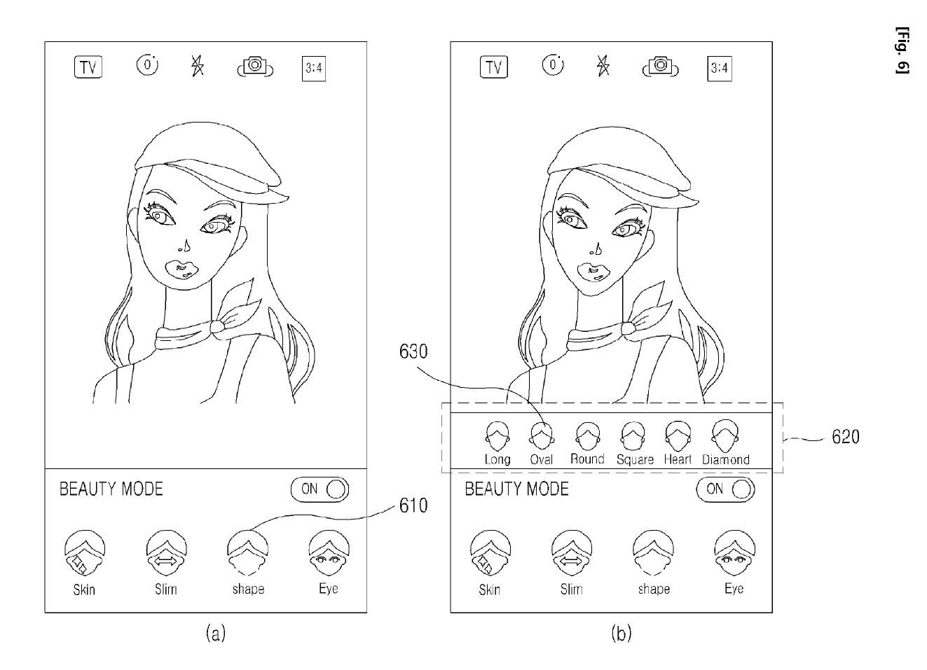

In the following, steps S220 through S240 will be explained in further detail with reference to FIGS. 5 and 6.

As illustrated in FIG. 5a, with the subject displayed on the screen, when a function button (510) including items for facial contour correction, for example, a beauty mode button, is selected by a user, various items (520) such as skin, slim, shape and eye functions which are provided in beauty mode are displayed in an area of the screen, as shown in FIG. 5b.

Here, a function button (530) which can turn beauty mode on/off is provided together. When the function button (530) is set to off, beauty mode functions are not applied, and if the function button (530) is set to on, beauty mode functions can be applied in real time.

When, among the various items provided in beauty mode, an item for correcting facial contours according to the present invention, for example, a shape item (610) is selected by a user as illustrated in FIG. 6a, various shapes of facial contour (620) are displayed, as illustrated in FIG. 6b, on part of the screen. When one facial contour item, for example, an oval facial contour item (630) is selected through user input, the human facial contour displayed on the screen is pre-processed and corrected in real time into an oval facial contour, and displayed on the screen.

Accordingly, as displayed on the screen of FIG. 6a, a facial contour of a person, for example, a round facial contour, is corrected and displayed in real time as an oval facial contour, as displayed on the screen in FIG. 6b.

Referring again to FIG. 2, when, after the facial contours of an object have been corrected into the first facial contour through Step S240, a photo or video capture command is received through user input, the subject displayed on the screen with its facial contours corrected is captured (S250, S260).

Here, the photo or video captured through Step S260 may be saved on a user device, for example, a smart phone, on which an application for the present invention has been installed.

Accordingly, the method according to one embodiment of the present invention, by pre-processing and correcting the facial contours of an object displayed on a viewfinder into any one of facial contours recommended from among a plurality of facial contours, is able to correct the face of a subject being captured to appear more attractive.

Further, as the method according to one embodiment of the present invention is able to capture the facial contours of a person applying a variety of facial contours to the subject, it is able to capture images of a subject with various facial contours.

Further, the method according to one embodiment of the present invention may, by using big data statistics to provide recommended facial contours corresponding to user information which has been set by a user, is able to recommend preferred facial contours according to age or age group, sex, race and skin color, accordingly allowing for correction of a user's own face or the face of another person into a facial shape preferred by the user or another person.

Whereas, in the foregoing explanation of the method of FIGS. 2 through 6, it has been explained that the number of facial contours provided in the application is predetermined, the present invention is not limited thereto. Through fine adjustments of a determined facial contour through user input, a large number of additional facial contours may be provided based on the predetermined facial contours.

That is, the method according to the present invention provides a fine adjustment function wherein a facial contour selected through user input can be finely adjusted. By performing fine adjustments on a selected facial contour, for example an oval facial contour, using the fine adjustment function, it is possible to provide a variety of facial contours wherein the oval facial contour has been finely adjusted.

Here, the present invention may provide a fine adjustment function by providing a plurality of fine adjustment items having predetermined fine adjustment values, or may provide a fine adjustment function by providing a fine adjustment value input window where the user can decide the fine adjustment value firsthand, or by providing a drag bar through which the fine adjustment value can be adjusted by dragging.

Accordingly, the facial contour selected in the present invention to correct the facial contours of an object in real time may include, in addition to a number of predetermined facial contours which are provided, facial contours based on the provided facial contours which have been finely adjusted through user input. That is, the facial contours provided in the present invention are not limited to a certain number, and may, in cases, include a large number of facial contours which have been modified through fine adjustments through user input.

FIG. 7 is a flow chart illustrating the operation of the method for correcting facial contours according to one embodiment of the present invention. The flow chart illustrates the operation of a method for correcting facial contours wherein a facial contour to be corrected is selected automatically, and wherein the facial contours of an object are corrected automatically to the automatically selected facial contour.

Referring to FIG. 7, in the method for correcting facial contours according to another embodiment of the present invention, an application for the present invention is executed, and a subject captured by a camera of a device on which the application is installed, for example, a subject including an object such as a person, is displayed on a screen (S710).

Depending on a user's selection, various filter functions, or various functions of a camera for capturing a subject may be applied to the subject displayed in Step S710.

When the subject is displayed on the screen in Step S710, a facial contour, for example, a first facial contour, is automatically selected (S720) among a plurality of facial contours based on user input which has been set by a user and saved beforehand, as well as big data statistics for each of the setting items included in user information.

Here, in Step S720, a facial contour, for example, an oval facial contour, may be selected automatically from among a plurality of facial contours which have been preset based on big data statistics for each of the setting items included in user information which has been set and saved beforehand by the user.

Here, the user information may include at least one of age (or age group), sex, race and skin color, and this information may be set firsthand by the user in an application for the present invention.

Further, in Step S720, by detecting the facial contours of a person captured by a camera, then additionally reflecting the detected facial contours of the person, a single facial contour may be selected automatically from among a plurality of facial contours.

When a single facial contour is selected through Step S720, the single facial contour which has been selected automatically, for example, an oval facial contour, is used to automatically pre-process and correct the facial contours of an object included in the subject (S730).

Herein in Step S730, as explained in FIG. 4, the face of an object is automatically recognized in a camera preview, extracting face feature points and tracking these in real time. By performing real time displacement mapping on the extracted face feature points using face feature points data for an automatically selected facial contour, that is, the first facial contour, the facial contours of an object can be corrected and modified in real time to the first facial contour.

The subject, including the object which has been automatically corrected in this manner, is displayed in real time on the viewfinder.

After the facial contour of the object has been corrected to the first facial contour through Step S730, when a photo or video capture command is received through user, the subject with corrected facial contours displayed on the screen is captured (S740, S750).

Here, the photo or video captured through Step S750 may be saved on a user device on which the application of the present invention is installed, for example, a smart phone.

As explained in the foregoing, the method according to one embodiment of the present invention, by automatically selecting a corrective facial contour for correcting facial contours of an object based on at least one of user information and big data statistics, then using the automatically selected facial contour to automatically correct the facial contours of an object, is able to correct the facial contours of a person being photographed to appear more attractive based on big data statistics and user information.

Further, whereas the method according to the present invention has been explained to correct facial contours by providing a plurality of predetermined facial contours to a user, then using the facial contour selected by the user to correct or modify in real time the facial contours of a subject, for example, the user, displayed in real time in the viewfinder, or by using a facial contour selected automatically based on big data statistics and user information to correct or modify in real time the facial contours of the user, the method according to the present invention is not limited hereto, and may, with the user's face being displayed after having been corrected to a facial contour pre-selected based on user selection or big data statistics, if a sticker or effect provided in the application is selected by the user, automatically correct the facial contours of the subject displayed in real time in the viewfinder to match the selected sticker or effect.

For example, with a subject, for example the face of a user, captured by a camera being displayed in real time in a viewfinder, after the user's face is corrected in real time using a facial contour selected by the user and then displayed, if a sticker or effect relating to flowers is selected among stickers or effects to be applied to the subject, the facial contours of the subject can be automatically corrected to a facial contour corresponding to such flower-related sticker or effect, for example an oval shaped facial contour, then displayed in the viewfinder.

In another example, with a subject, for example the face of a user, captured by a camera being displayed in real time in a viewfinder, after the user's face is corrected in real time using a facial contour selected by the user and then displayed, if a sticker or effect relating to bread is selected among stickers or effects to be applied to the subject, the facial contours of the subject can be automatically corrected to a facial contour corresponding to such bread-related sticker or effect, for example a round shaped facial contour, then displayed in the viewfinder.

In yet another example, with a subject, for example the face of a user, captured by a camera being displayed in real time in a viewfinder, after the user's face is corrected in real time using a facial contour selected by the user and then displayed, if a sticker or effect relating to “Yuna Kim” is selected among stickers or effects to be applied to the subject, the facial contours of the subject can be automatically corrected to a facial contour corresponding to such sticker or effect relating to “Yuna Kim”, for example, Yuna Kim's facial contours, then displayed in the viewfinder.

Of course, depending on the situation, the facial contours selected automatically depending on the sticker or effect selected by a user may be determined through big data statistics, as explained in the foregoing, and user information set by a user, for example, age, sex, race, skin color, height and body weight, etc. can be reflected additionally in showing facial contours which correspond to a sticker or effect, and correcting the facial contours of a user to a shown facial contour. Here, if user information is reflected, even if the same sticker or effect is selected, the facial contour used to correct the user's facial contours may differ depending on user information.

As explained in the foregoing, the method according to the present invention, by correcting the facial contours of a subject in real time using a facial contour selected based on user selection or big data statistics from among facial contours provided beforehand to correct the facial contours of a subject, displaying the corrected facial contours, then, if a sticker or effect to be applied to the subject being captured in real time by a camera is selected, by correcting the facial contours of the subject correspondingly, is able to correct the facial contours of a subject in accordance with a sticker or effect which is applied, thereby correcting the facial contours of a subject in a manner that suits the sticker or effect applied to the subject.

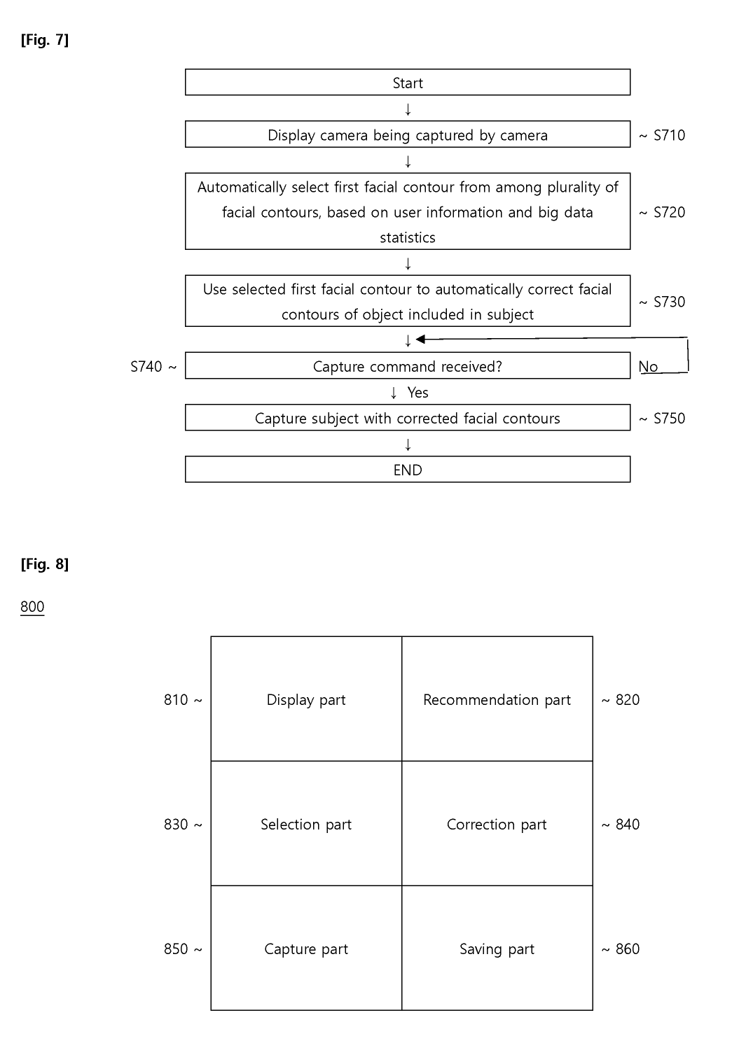

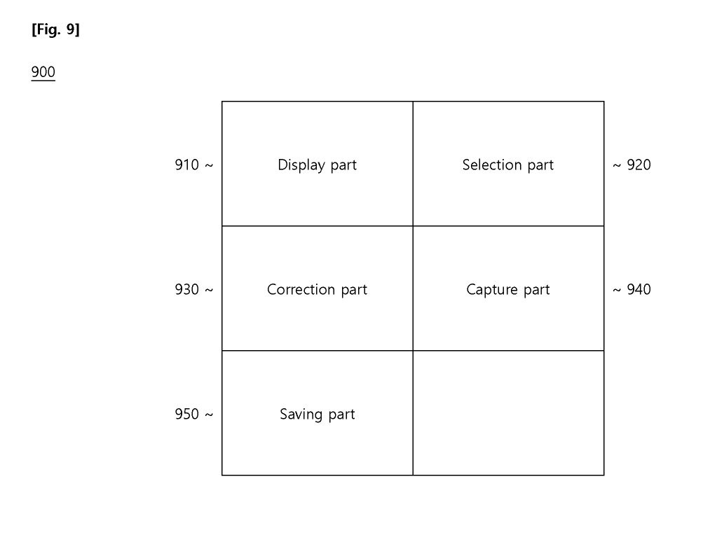

FIG. 8 illustrates the composition of the device for correcting facial contours according to one embodiment of the present invention. The configuration of a device which carries out the operations illustrated in FIGS. 2 through 6 is represented, and the device may be included in a device equipped with a camera, such as a smart phone.

Referring to FIG. 8, the device (800) according to one embodiment of the present invention comprises a display part (810), recommendation part (820), selection part (830), correction part (840), capture part (850) and a saving part (860).

The display part (810) displays a subject being captured by a camera.

Here, the display (810) may display not only a subject being captured by the application of the present invention, but also photos or video captured according to a user's capture commands, and all information related to the present invention may be displayed on a screen.

The recommendation part (820) provides the user with recommended facial contours corresponding to user information which has been saved beforehand by the user, the recommended facial contours to be used for facial contour correction.

Here, the recommendation part (820) may, by detecting the facial contours of an object included in the subject being captured, and additionally reflecting the detected facial contours, provide, from among a plurality of facial contours, recommended facial contours which correspond to user information and the facial contours of the object.

Further, the recommendation part (820) may provide recommended facial contours from among a plurality of facial contours, based on user information and big data statistics.

That is, the recommendation part (820) may provide recommended facial contours based on at least one of age, sex, race and skin color, which included in user information, provide recommended facial contours corresponding to user information based on big data statistics for each of the setting items included in user information, or, as needed, provide recommended facial contours by additionally reflecting the facial contours of the object.

Such recommendation part (820) may selectively e deleted depending on the situation.

The selection part (830) selects, based on user input, one facial contour for using in correcting the facial contours of the object from among the recommended facial contours provided by the recommendation part (820) or from among a plurality of predefined facial contours.

The correction part (840) corrects the facial contours of the object captured by the camera to the facial contour selected by the selection part.

Here, the correction part (840) may, by automatically recognizing the face of an object in a camera preview, extracting face feature points, tracking these face feature points in real time, then using a face feature point DB for each of the plurality of facial contours to perform real time displacement mapping of the facial feature points extracted from the face of the object against face feature point information for the facial contour selected by the selection part, correct the facial contours of the object.

Here, in the correction part (840), the face feature points which have been displacement mapped in real time may be mapped as vertex data for OpenGL drawing to render an image captured by a user into a texture, thereby correcting and modifying the facial contours of the object into the facial contour selected by the selection part.

The capture part (850) captures images of the subject using the camera in capture modes such as photo capture mode or video capture mode.

The saving part (860) saves all data necessary for carrying out the present invention, for example algorithms, applications, big data statistics, face feature point data for each of a plurality of facial contours, captured and saved image data, and user information, etc.

Of course, it shall be self-evident to a PHOSITA that the device according to one embodiment of the present invention is able to perform all of the functions stated in the method explained in FIGS. 2 through 6.

FIG. 9 illustrates the composition of the device for correcting facial contours according to another embodiment of the present invention. The configuration of a device which carries out the operations illustrated in FIG. 7 is represented, and the device may be included in a device equipped with a camera, such as a smart phone.

Referring to FIG. 9, the device (900) according to another embodiment of the present invention comprises a display part (910), selection part (920), correction part (930), capture part (940) and a saving part (950).

The display part (910) displays a subject being captured by a camera.

Here, the display (910) may display not only a subject being captured by the application of the present invention, but also photos or video captured according to a user's capture commands, and all information related to the present invention may be displayed on a screen.

The selection part (920) selects, based on user information which has been set and saved by a user beforehand, and big data statistics for each of the setting items included in user information, a single facial contour, for example a first facial contour, from among a plurality of facial contours.

Here, the selection part (920) may, based on big data statistics for each of the setting items in user information set and saved beforehand by a user, automatically select any one facial contour from among a plurality of preset facial contours.

Further, the selection part (920) may, by detecting facial contours of the person being captured by a camera, and additionally reflecting the detected person's facial contours, automatically select any one facial contour from among a plurality of facial contours.

The correction part (930) corrects the facial contours of the object captured by the camera to the facial contour selected by the selection part (920).

Here, the correction part (930) may, by automatically recognizing the face of an object in a camera preview, extracting face feature points, tracking these face feature points in real time, then using a face feature point DB for each of the plurality of facial contours to perform real time displacement mapping of the facial feature points extracted from the face of the object against face feature point information for the facial contour selected by the selection part, correct the facial contours of the object.

Here, in the correction part (930), the face feature points which have been displacement mapped in real time may be mapped as vertex data for OpenGL drawing to render an image captured by a user into a texture, thereby correcting and modifying the facial contours of the object into the facial contour selected by the selection part.

The capture part (940) captures images of the subject using the camera in capture modes such as photo capture mode or video capture mode.

The saving part (950) saves all data necessary for carrying out the present invention, for example algorithms, applications, big data statistics, face feature point data for each of a plurality of facial contours, captured and saved image data, and user information, etc.

Of course, it shall be self-evident to a PHOSITA that the device according to one embodiment of the present invention is able to perform all of the functions stated in the method explained in FIG. 7.

The system or device explained in the foregoing may be realized through hardware components, software components, and/or combinations of hardware components and software components. For example, the system, devices and components explained in the embodiments may be realized through a processor, controller, ALU (arithmetic logic unit), digital signal processor, microcomputer, FPA (field programmable array), PLU (programmable logic unit), microprocessor, or another device able to execute and reply to instructions, such as one or more general or special purpose computers. The processing device may execute an operating system (OS) and at least one software application which is executed within the operating system. Further, the processing device may, in response to the execution of software, access, save, manipulate, process and generate data. Whereas in some cases the use of a single processing device is explained to facilitate understanding, a PHOSITA will be able to know that the processing device may comprise a plurality of processing elements and/or a plurality of types of processing elements. For example, the processing device may comprise a plurality of processors or one processor and a controller. Further, other processing configurations such as parallel processors are also possible.

The software may comprise a computer program, code, instructions, or a combination of at least one of these, and the software may configure the processing device to operate as desired, or may command the processing device independently or collectively. The software and/or data may be, to be interpreted by a processing device or to provide instructions or data to a processing device, be temporarily or permanently embodied in some type of machine, component, physical device, virtual equipment, computer storage medium or device, or a transmitted signal wave. The software may be distributed across a computer system which is connected by a network, and may be stored or executed in a distributed manner. The software and data may be saved on one or more computer-readable recording media.

The method according to the embodiments may be realized in the form of program instructions which can be executed through various computer means. The computer-readable media may comprise solely program commands, data files, and data structures, etc., or a combination of these. The program instructions recorded in the media may be such that have been designed and configured specially for the embodiments, or may be of public knowledge to a person skilled in the art of computer software. Examples of computer-readable recording media include magnetic media such as hard disks, floppy disks and magnetic tape, optical media such as CD-ROMs and DVDs, magneto-optical media such as floptical disks, and hardware devices specially configured to store and execute program instructions, such as ROM, RAM, and flash memory, etc. Examples of program instructions include not only machine language code such as that generated by compilers, but also advanced language code which can be executed by a computer through use of an interpreter, etc. The hardware device may be configured to operate as one or more software modules to carry out the operation of the embodiments, and the reverse is also possible.

### MODE(S) FOR CARRYING OUT THE INVENTION

Whereas the embodiments have been described with reference to limited embodiments and drawings in the above, various changes and modifications based on the foregoing description would be possible for a PHOSITA. For example, appropriate results may be accomplished even if the art which has been described is carried out in an order different from that which is described, and/or if the components of the described system, structure, device, circuit, etc. have been combined or joined in a manner different from that which has been described, or replaced or substituted with other components or equivalents.

Accordingly, other implementations, other embodiments and other equivalents to the scope of claims shall be included in the scope of the appended claims.

What is claimed is:

1. A method for correcting facial contours, the method comprising:
a step of displaying a subject captured by a camera;
a step of selecting, based on user input, any one of a plurality of facial contours for correcting the facial contours of an object included in the subject;
a step of using the any one selected facial contour to correct the facial contours of the object in real time, and;
a step of generating an image of the subject, including the object whose facial contours have been corrected, upon receiving a capture command through user input, where:
in the step of selecting based on user input, recommended facial contours corresponding to user information are provided based on information on each of the selection items in user information which has been saved beforehand, and any one of the recommended facial contours provided is selected based on the user input;
the user information includes at least one of age, sex, race and skin color, and;
in the step of selecting based on user input, data on the preferred facial contours according to each of age, sex, race and skin color, which are setting items in the user information, is collected, and the collected data is used to provide the recommended facial contours.

2. The method for correcting facial contours according to claim 1, characterized in that, in the step of selecting based on user input, the recommended facial contours are provided by detecting the facial contours of the object and additionally reflecting the detected facial contours.

3. The method for correcting facial contours according to claim 1, characterized in that, in the step of correcting the facial contours of the object, the face of the object is recognized to extract face feature points, then, using face feature point information for the selected facial contour, performing real time displacement mapping of the extracted face feature points, thereby correcting the facial contours of the object.

4. The method for correcting facial contours according to claim 1, characterized in that the step of correcting the facial contours of the object comprises:
a step of fine adjusting the selected facial contour based on user input, and;
a step of using the fine adjusted facial contour to correct the facial contours of the object in real time.

5. A method for correcting facial contours, the method comprising:
a step of displaying a subject captured by a camera;
a step of automatically selecting any one of a plurality of facial contours which have been preset based on big data statistics for each of setting items in user input which has been set and saved beforehand by a user;
a step of using the any one automatically selected facial contour to correct the facial contours of the object in real time, and;
a step of generating an image of the subject, including the object whose facial contours have been corrected, upon receiving a capture command through user input, where:
the user information includes at least one of age, sex, race and skin color, and;
in the step of automatically selecting the any one facial contour, data on the preferred facial contours according to each of age, sex, race and skin color, which are setting items in the user information, is collected, and the collected data is used to provide the recommended facial contours.

6. The method for correcting facial contours according to claim 5, characterized in that, in the step of automatically selecting the any one facial contour, the any one facial contour is automatically selected by detecting the facial contours of the object and additionally reflecting the detected facial contours.

7. The method for correcting facial contours according to claim 5, characterized in that, in the step of automatically correcting the facial contours of the object, the face of the object is recognized to extract face feature points, then, using face feature point information for the selected facial contour, real time displacement mapping of the extracted face feature points is performed, thereby automatically correcting the facial contours of the object.

8. A device for correcting facial contours, the device comprising:
a display part which displays a subject being captured by a camera;
a selection part wherein any one of a plurality of facial contours for correcting the facial contours of an object included in the subject is selected based on user input;
a correction part wherein the selected facial contour is used to correct the facial contours of the object in real time, and;
a capture part which, upon receiving a capture command through user input, generates an image of the subject including the object whose facial contours have been corrected,
and further comprising a recommendation part which, based on information on each of setting items in user information which has been saved beforehand, provides recommended facial contours corresponding to the user information from among the plurality of facial contours, wherein:
the user information includes at least one of age, sex, race and skin color, and;
the recommendation part selects data on the preferred facial contours according to each of age, sex, race and skin color, which are setting items in the user information, and uses the collected data to provide the recommended facial contours.

9. The device for correcting facial contours according to claim 8, characterized in that, in the recommendation part, the recommended facial contours are provided by detecting the facial contours of the object and additionally reflecting the detected facial contours.

10. The device for correcting facial contours according to claim 8, characterized in that, in the correction part, the face of the object is recognized to extract face feature points, then, using face feature point information for the selected facial contour, real time displacement mapping of the extracted face feature points is performed, thereby correcting the facial contours of the object.

11. The device for correcting facial contours according to claim 8, characterized in that, in the correction part, if the selected facial contour is fine adjusted based on user input, the fine adjusted facial contour is used to correct the facial contours of the object in real time.

12. A device for correcting facial contours, the device comprising:
a display part which displays a subject being captured by a camera;
a selection part wherein any one of a plurality of facial contours which have been preset based on big data statistics for each of setting items in user input which has been set and saved beforehand by a user is automatically selected;
a correction part wherein the automatically selected facial contour is used to correct the facial contours of the object in real time, and;
a capture part which, upon receiving a capture command through user input, generates an image of the subject including the object whose facial contours have been corrected, wherein:
the user information includes at least one of age, sex, race and skin color, and where, in the step of automatically selecting a facial contour, data is collected on the preferred facial contours according to each of age, sex, race and skin color, which are setting items in the user information, and the collected data is used to select the one facial contour from among the plurality of facial contours.

13. The device for correcting facial contours according to claim 12, characterized in that, in the selection part, the facial contour is automatically selected by detecting the facial contours of the object and additionally reflecting the detected facial contours.

14. The device for correcting facial contours according to claim 12, characterized in that, in the correction part, the face of the object is recognized to extract face feature points, then, using face feature point information for the selected facial contour, real time displacement mapping of the extracted face feature points is performed, thereby automatically correcting the facial contours of the object.

15. A method for correcting facial contours, the method comprising:
a step of displaying a subject being captured by a camera;
a step of selecting a facial contour for correcting the facial contours of an object included in the subject;
a step of using the selected facial contour to correct the facial contours of the object in real time;
a step of, in response to the selection of at least one sticker or effect to be applied to the subject from among a plurality of stickers or effects which are provided beforehand, viewing facial contours corresponding to the selected sticker or effect;
a step of using the viewed facial contours to correct, in real time, the facial contours of the object included in the subject, and;
a step of generating an image of the subject, including the object whose facial contours have been corrected, upon receiving a capture command through user input.

16. The method for correcting facial contours according to claim 15, characterized in that, in the step of viewing the facial contours, user information which has been set and saved beforehand by a user is reflected when viewing the facial contours corresponding to the selected sticker or effect.

17. The method for correcting facial contours according to claim 15, characterized in that, in the step of viewing the facial contours, if the selected sticker or effect includes a human character, facial contours corresponding to the facial contours of the human character are viewed.
